(19) United States
(12) Patent Application Publication
(10) Pub. No.: US 2014/0325434 A1
(43) Pub. Date: Oct. 30, 2014

(54) ELECTRONIC APPARATUS CONTROLLING METHOD

(71) Applicant: MEDIATEK INC., Hsin-Chu (TW)

(72) Inventors: Tzu-Wen Chang, Taipei City (TW); Shang-Lun Ting, Taipei City (TW)

(73) Assignee: MEDIATEK INC., Hsin-Chu (TW)

(21) Appl. No.: 14/058,307

(22) Filed: Oct. 21, 2013

Related U.S. Application Data
(60) Provisional application No. 61/816,271, filed on Apr. 26, 2013.

(51) Int. Cl. G06F 3/0484; G06F 3/0481

(52) U.S. Cl. CPC G06F 3/0484; G06F 3/04817
USPC 715/790

(57) ABSTRACT

An electronic apparatus controlling method, applied to an electronic apparatus displaying a first window and second window thereon. The electronic apparatus controlling method comprises: (a) determining one of the first window and the second window as a target window; and (b) displaying an input window on the electronic apparatus if the electronic apparatus receives an input triggering signal; wherein the input window does not substantially overlap any part of the target window.

### CROSS REFERENCE TO RELATED APPLICATIONS

This application claims the benefit of U.S. Provisional Application No. 61/816,271, filed on Apr. 26, 2013, the contents of which are incorporated herein by reference.

### BACKGROUND

The panel size of mobile electronic apparatus becomes larger in recent years, therefore multiple windows would have more application in such mobile electronic apparatus. Multiple windows mean that the electronic apparatus can simultaneously operate more than one application. For example, a user may watch a video, read emails and play games via a plurality of windows at the same time.

FIG. 1 is a related art mobile electronic apparatus utilizing multiple windows. As shown in FIG. 1, the mobile electronic apparatus E displays a first window W₁ and a second window W₂. If a user wants to edit one application operated in the first window W₁ or the second window W₂, an input window IW is displayed. For example, if a user wants to fill in a blank displayed on the first window W₁, a virtual keyboard is displayed as the input window IW, such that the user can input commands via the virtual keyboard. However, the input window IW may cover the window which the user is focusing on, thus it is inconvenient for the user.

### SUMMARY

One objective of the present application is to provide an electronic apparatus controlling method that can prevent the window that the user focuses on from being covered by the input window.

One embodiment of the present application discloses an electronic apparatus controlling method applied to an electronic apparatus in a portrait mode. The electronic apparatus displays a first window and second window thereon an displays a input window if the electronic apparatus receives an input triggering signal. The electronic apparatus controlling method comprises: (a) before displaying the input window, determining which one of the first window and the second window is the input window displayed in; (b) displaying the input window if the step (a) determines that the input window is displayed on the second window of the electronic apparatus, wherein the input interface displayed via the step (b) does not substantially overlap the first window; and (c) swapping the first window and the second window and displaying the input window if the step (a) determines that the input window is displayed on the first window of the electronic apparatus, wherein the input window does not substantially overlap the second window.

Another embodiment of the present application discloses an electronic apparatus controlling method, applied to an electronic apparatus in a landscape mode. The electronic apparatus displays a first window and second window thereon and displays a input window if receiving an input triggering signal generated if an input triggering icon displayed on the electronic apparatus is activated. The electronic apparatus controlling method comprises: (a) before displaying the input window, determining if the input window substantially overlaps the input triggering icon; (b) displaying the input window if the step (a) determines the input window does not substantially overlap the input triggering icon; and (c) moving the first window or the second window which the input triggering icon is provided in, if the step (a) determines the input window substantially overlaps the input triggering icon, thereby the input window does not substantially overlap the input triggering icon.

Still another embodiment of the present application discloses an electronic apparatus controlling method, applied to an electronic apparatus displaying a first window and second window thereon. The electronic apparatus controlling method comprises: (a) determining one of the first window and the second window as a target window; and (b) displaying an input window on the electronic apparatus if the electronic apparatus receives an input triggering signal; wherein the input window does not substantially overlap any part of the target window.

In view of above-mentioned embodiments, the window that the user desires to see can be avoided to be covered by the input window. Additionally, the present application provides methods to display the input window for different situations, such that the user can select most suitable displaying method corresponding to different requirements.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a related art mobile electronic apparatus utilizing multiple windows.

FIG. 2 is a flow chart illustrating the operation for a mobile electronic apparatus in a portrait mode according to one embodiment of the present application.

FIG. 3-FIG. 6 are schematic diagrams illustrating embodiments according to the flow chart in FIG. 2.

FIG. 7-FIG. 11 are schematic diagrams illustrating extending embodiments for the embodiments shown in FIG. 2-FIG. 6.

FIG. 12 is a flow chart illustrating the operation for a mobile electronic apparatus in a portrait text priority mode according to one embodiment of the present application.

FIG. 13 is a schematic diagram illustrating embodiments according to the flow chart in FIG. 11.

FIG. 14 and FIG. 15 are schematic diagrams illustrating extending embodiments for the embodiments shown in FIG. 12, FIG. 13.

FIG. 16 is a flow chart illustrating the operation for a mobile electronic apparatus in a landscape mode according to one embodiment of the present application.

FIG. 17-FIG. 22 are schematic diagrams illustrating embodiments according to the flow chart in FIG. 13.

FIG. 23-FIG. 26 are schematic diagrams illustrating the mobile electronic apparatuses in a rotation mode according to the embodiments of the present application.

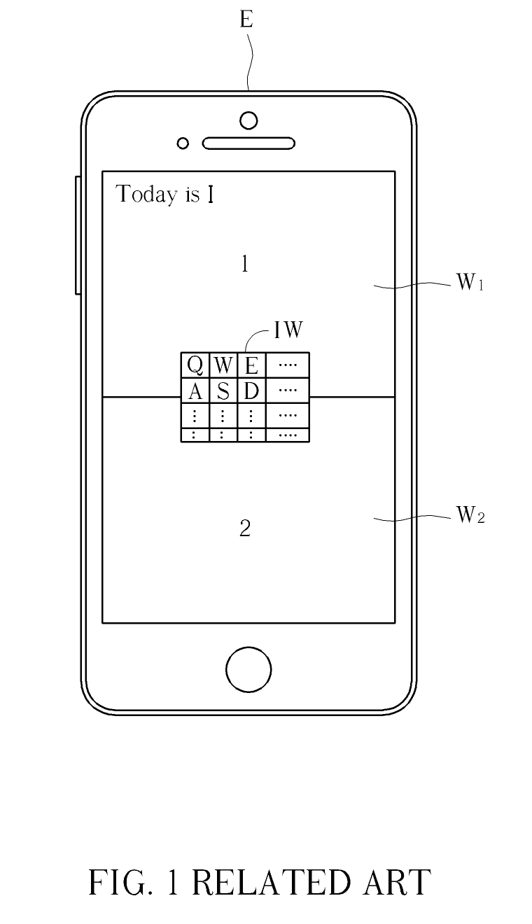

### DETAILED DESCRIPTION

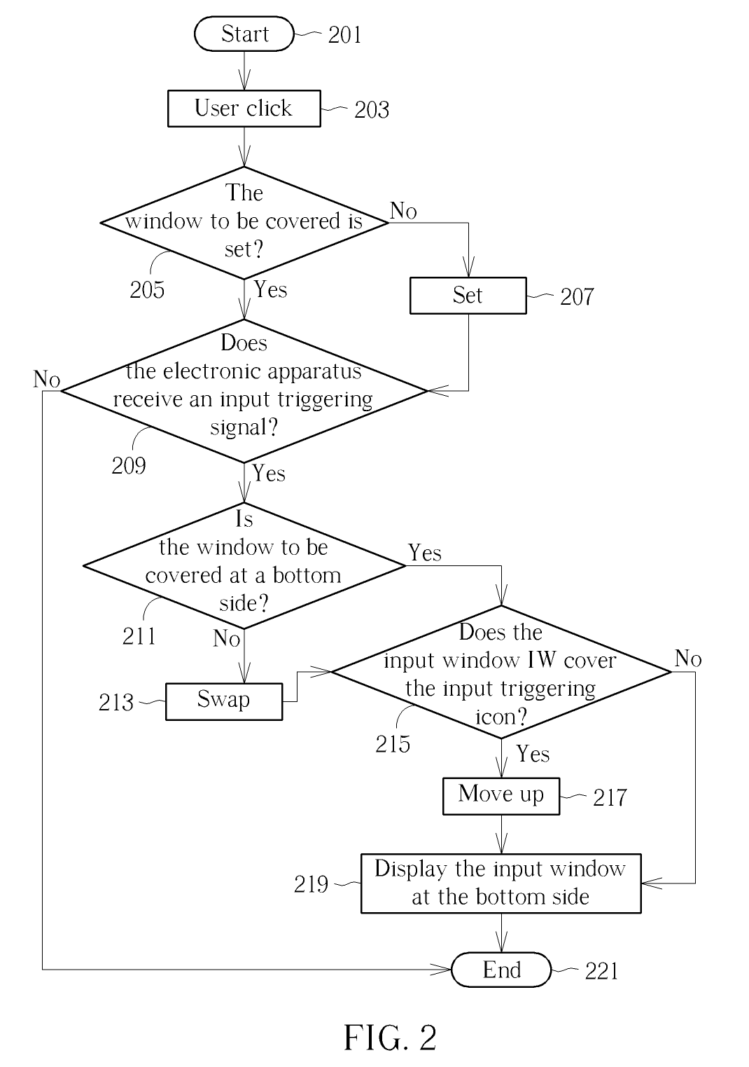

FIG. 2 is a flow chart illustrating the operation for a mobile electronic apparatus in a portrait mode according to one embodiment of the present application. As shown in FIG. 2, the flowchart comprises the following steps:

Step 201

Start.

Step 203

User click (ex. touch the screen of the electronic apparatus or any button on the electronic apparatus), which indicates the user may wants to edit the application displayed on the electronic apparatus. However, it does not mean that application editing is limited to be triggered by a user clicking.

Step 205

Determine if the window to be covered by the input window is set. If not, go to step 207 to set the window to be covered. If yes, go to step 209.

Step 207

Set the window to be covered.

Step 209

Determine if the electronic apparatus receives an input triggering signal. If yes, go to step 211. If not, go to step 221.

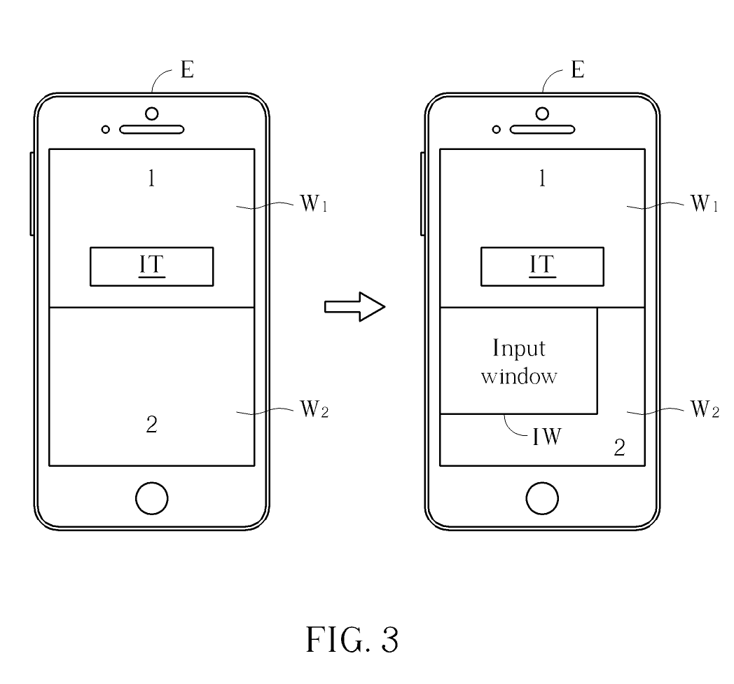

The input triggering signal can be generated via many methods. For example, the input triggering signal can be generated via activating an input triggering icon shown IT shown in FIG. 3 (ex, the user touches the input triggering icon shown as IT). Alternatively, the input triggering signal can be generated if the user performs a gesture or provides a voice command to the electronic apparatus.

Step 211

Determine if the window to be covered is at bottom side? If not, go to step 213. If yes, go to step 215.

Step 213

Swap the first window and the second window. The first window and the second window are two windows displayed on the electronic apparatus, which will be described for more detail in the following embodiments.

Step 215

Determine if the input window IW covers the input triggering icon? If yes, go to step 217, if not, go to step 219.

Step 217

Move up the first window and the second window

Step 219

Display the input window at bottom side.

Step 221

End.

FIG. 3-FIG. 6 are schematic diagrams illustrating embodiments according to the flow chart in FIG. 2. In FIG. 3, the input triggering window IT is provided on a first window W₁ at the top side of the electronic apparatus and the window to be covered is the second window W₂ at the bottom side of the electronic apparatus E. Therefore, the embodiment in FIG. 3 follows the steps 211, 215, 219 such that the input window IW is displayed at the bottom side. Please note the input window IW does not substantially overlap the first window W₁, and covers at least part of the second window W₂. That is, the input window IW can cover only part of the second window W₂ and can cover all region of the second window W₂ as well. The following embodiment also follows such rules.

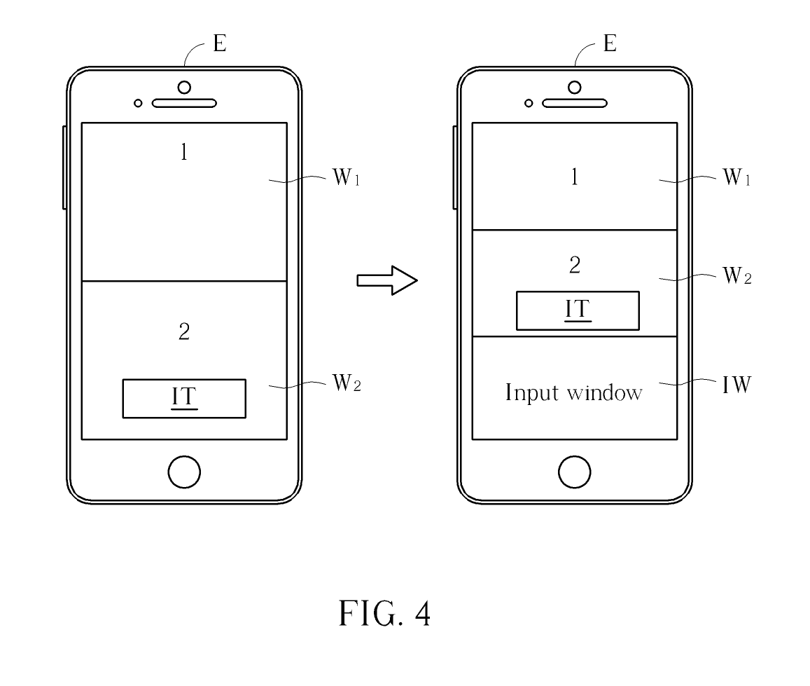

In FIG. 4, the input triggering window IT is on the second window W₂ at the bottom and the window to be covered is still the second window W₂. Therefore, the embodiment in FIG. 4 follows the steps 211, 215, 217, 219 such that the input window IW is displayed at the bottom side but the first window W₁ and the second window W₂ are moved up such that the input window IW substantially overlaps neither the first window W₁ nor the second window W₂.

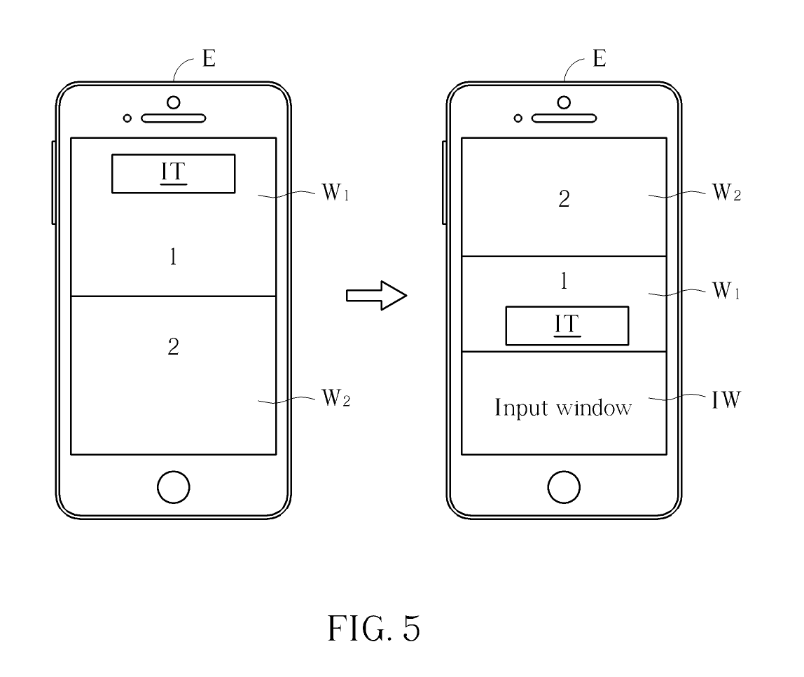

In FIG. 5, the input triggering window IT is on the first window W₁ at the top side and the window to be covered is still the first window W₁. Therefore, the embodiment in FIG. 5 follows the steps 211, 213, 215, 219 such that the first window W₁ and the second window W₂ are swapped and the input window IW is displayed at the bottom side and on the first window W₁.

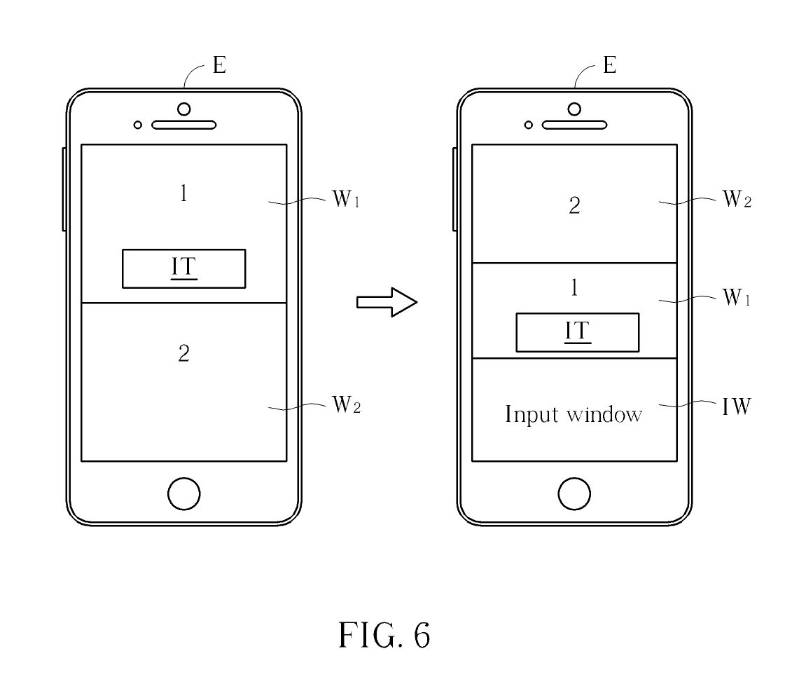

In FIG. 6, the input triggering window IT is provided on the first window W₁ at the top side and the window to be covered is still the first window W₁. However, in FIG. 5 the input window IW does not cover the input triggering icon IT but in FIG. 6 the input window IW may cover the input triggering icon IT. Therefore, the embodiment in FIG. 6 follows the steps 211, 213, 215, 217, 219 such that the first window W₁ and the second window W₂ are swapped and moved up, and the input window IW is displayed at the bottom side such that the input window IW substantially overlaps neither the first window W₁ nor the second window W₂.

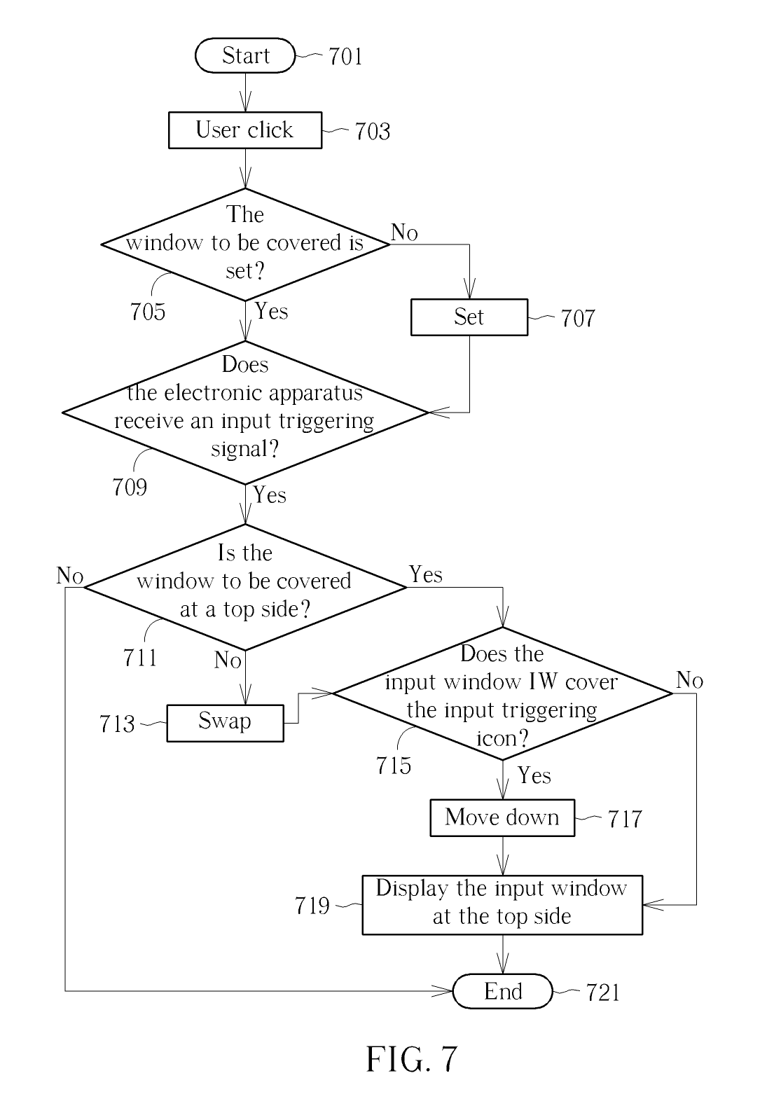

FIG. 7-FIG. 11 are schematic diagrams illustrating extending embodiments for the embodiments shown in FIG. 2-FIG. 6. FIG. 7 is a flow chart similar with the FIG. 2. The differences between the FIG. 2 and the FIG. 7 are as below:

The step 711 comprises “Determine if the window to be covered is at the top side” instead of “Determine if the window to be covered is at the bottom side” in the step 211. Also, the step 717 comprises “move down” rather than “move up” in the step 217. Additionally, the step 719 comprises “Display the input window at the top side.” rather than “Display the input window at the bottom side.” in the step 219.

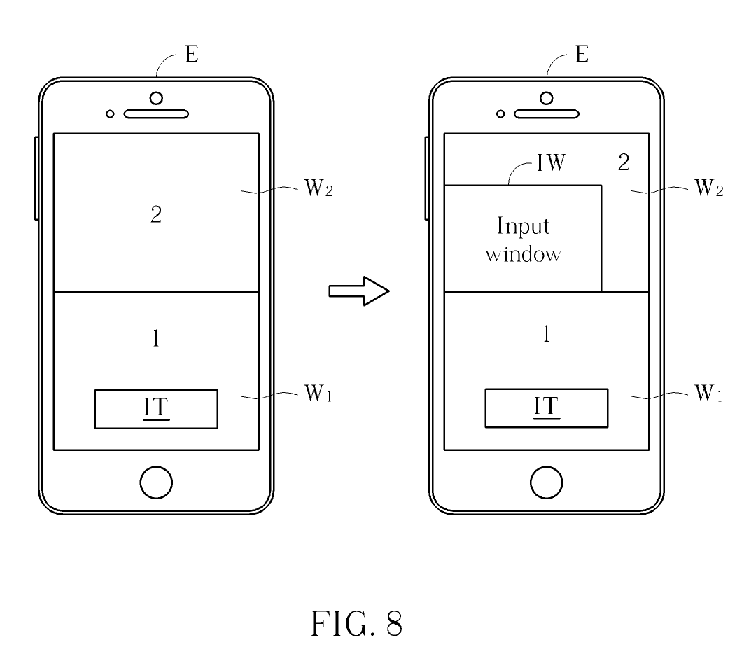

FIG. 8 illustrates an embodiment corresponding to the embodiment of FIG. 3. In FIG. 8, the input triggering window IT is on a first window W₁ at the bottom side of the electronic apparatus and the window to be covered is the second window W₂ at the top side of the electronic apparatus E. Therefore, the embodiment in FIG. 8 follows the steps 711, 715, 719 such that the input window IW is displayed at the top side.

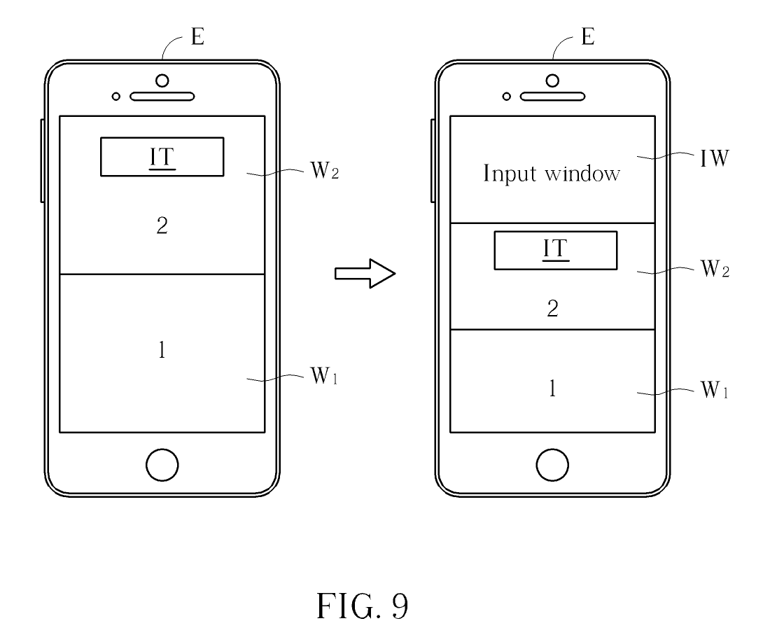

FIG. 9 illustrates an embodiment corresponding to the embodiment of FIG. 4. In FIG. 9, the input triggering window IT is on the second window W₂ at the top side and the window to be covered is still the second window W₂. Therefore, the embodiment in FIG. 9 follows the steps 711, 715, 717, 719 such that the input window IW is displayed at the top side but the first window W₁ and the second window W₂ are moved down.

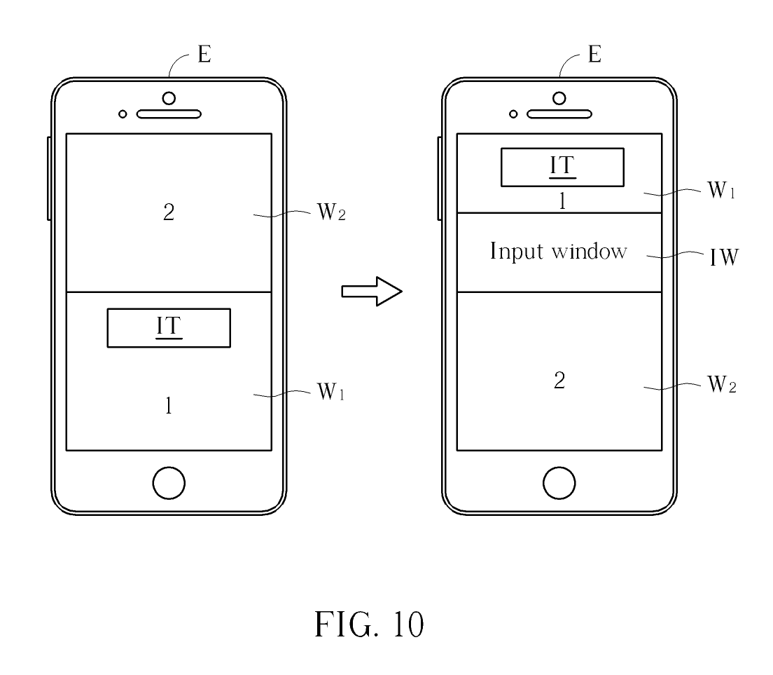

FIG. 10 illustrates an embodiment corresponding to the embodiment of FIG. 5. In FIG. 10, the input triggering window IT is on the first window W₁ at the bottom side and the window to be covered is still the first window W₁. Therefore, the embodiment in FIG. 10 follows the steps 711, 713, 715, 719 such that the first window W₁ and the second window W₂ are swapped and the input window IW is displayed at the top side on the first window W₁. Please note in the embodiment of FIG. 10 the second window W₂ is moved down after swapped such that the step 717 is included. However, in another embodiment the second window W₂ can be only swapped but not moved down. In such embodiment, the step 717 can be removed.

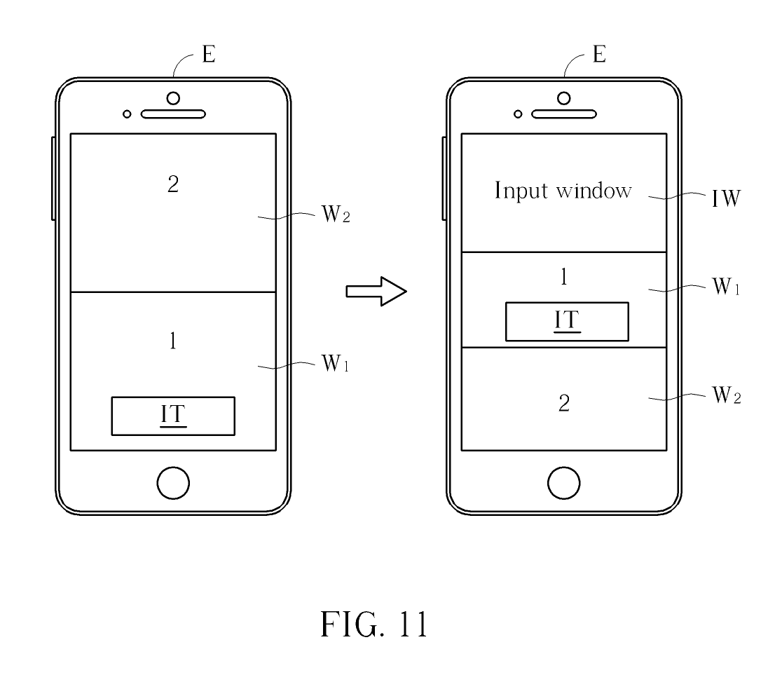

FIG. 11 illustrates an embodiment corresponding to the embodiment of FIG. 6. In FIG. 11, the input triggering window IT is on the first window W₁ and the window to be covered is still the first window W₁. However, in FIG. 10 the input window IW does not cover the input triggering icon IT but in FIG. 11 the input window IW may cover the input triggering icon IT. Therefore, the embodiment in FIG. 11 follows the steps 711, 713, 715, 717, 719 such that the first window W₁ and the second window W₂ are swapped and moved down, and the input window IW is displayed at the top side.

Please note the above mentioned flow chart only illustrates an example and do not mean to limit to the scope of the present invention to specific displaying orders. Take the embodiment in FIG. 11 for example, it can firstly display the input window IW and then swap the first window W₁ and the second window W₂, but it can also firstly swap the first window W₁ and the second window W₂ and then display the input window IW. That is, the steps that can perform the result shown in all figures should all fall in the scope of the present invention. The following embodiment also follows such rules.

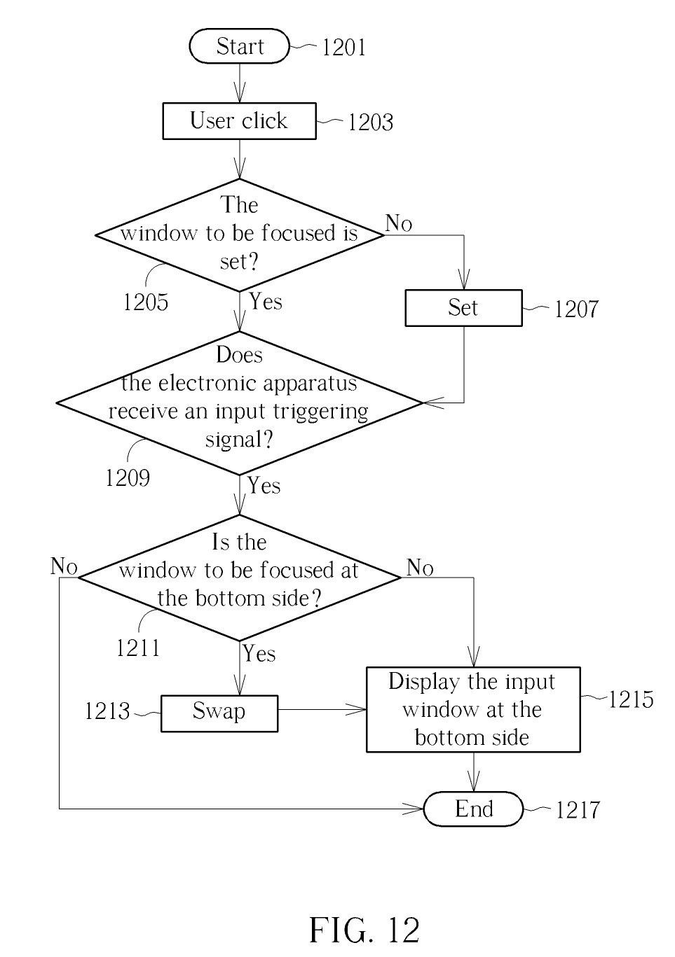

The electronic apparatus according the present application can operate according to other flow charts. FIG. 12 is a flow chart illustrating the operation for a mobile electronic apparatus in a portrait text priority mode according to one embodiment of the present application. In this mode, the window to be focused rather than the window to be covered is selected.

FIG. 12 comprises the steps 1201-1217. The steps 1201 to 1209 are similar as the steps 201 to 209, thus are omitted for brevity here. However, please note the step 1205 is changed to be “Determine if the window to be focused is set” rather than “Determine if the window to be covered is set.” in the step 205. Additionally, the step 1207 comprises “Set the window to be focused.” Rather than “Set the window to be covered.” in the step 207. Various methods can be performed to reach the step of setting the window to be covered or the window to be focused. For example, the user can set the window to be covered or the window to be focused via utilizing a setting interface displayed by the electronic apparatus. Alternatively, the user can touch or perform a specific gesture to the first window or the second window to select the first window or the second window as the window to be covered or the window to be focused. However, please note the methods can be performed to reach the step of setting the window to be covered or the window to be focused are not limited to above-mentioned examples.

The contents for the steps 1211-1215 are as follows:

Step 1211

Determine if the window to be focused is at the bottom side.

If yes, go to step 1213. If not, go to step 1215.

Step 1213

Swap the first window and the second window.

Step 1215

Display the input window at the bottom side.

Step 1217

End.

Please refer to FIG. 3 again. AS describe above, in FIG. 3, the input triggering window IT is on a first window W₁ at the top side of the electronic apparatus and the window to be focused is the first window W₁ at the top side of the electronic apparatus E. Therefore, the embodiment in FIG. 3 follows the steps 1211, 1215, 1217 such that the input window IW is displayed at the bottom side.

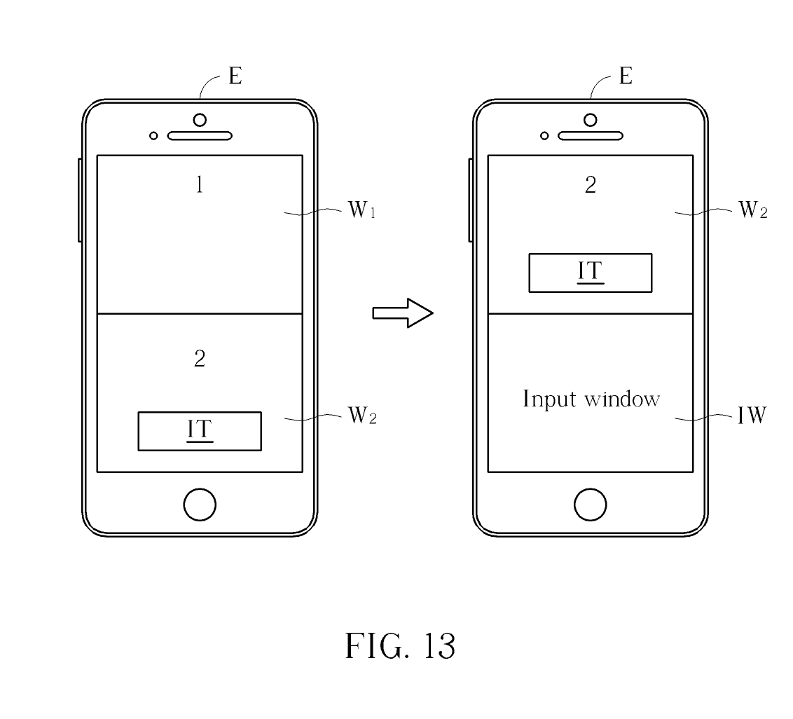

In FIG. 13, the input triggering icon IT is on the second window W₂ at the bottom side and the window to be focused is the second window W₂ as well. Therefore, the embodiment of FIG. 13 follows the steps of 1211, 1213, and 1215, thus the first window W₁, the second window W₂ are swapped and the input window IW is displayed at the bottom side.

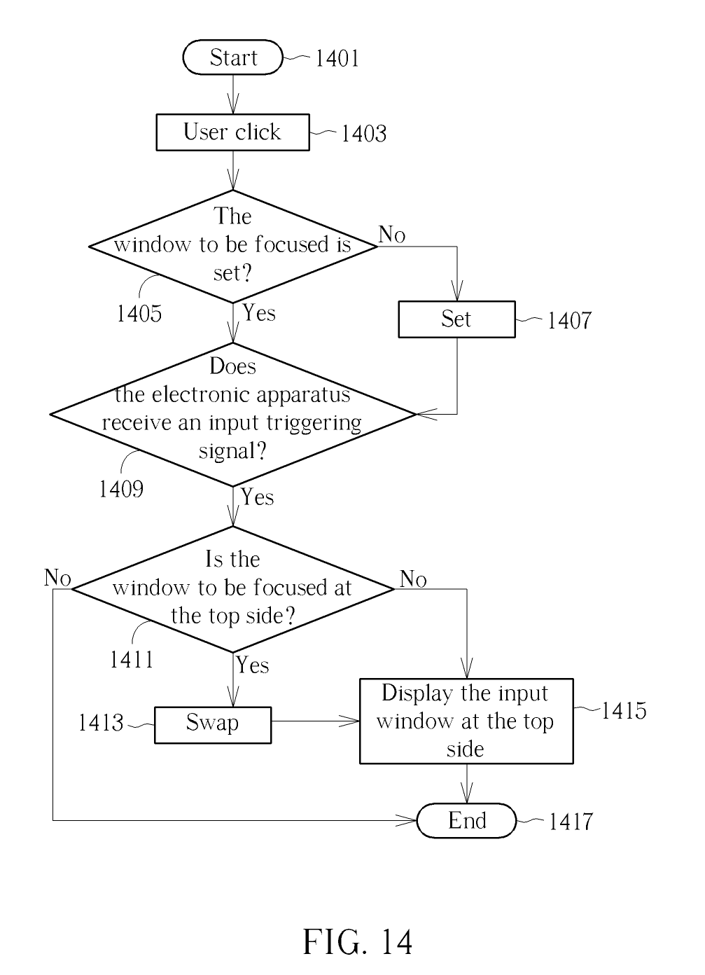

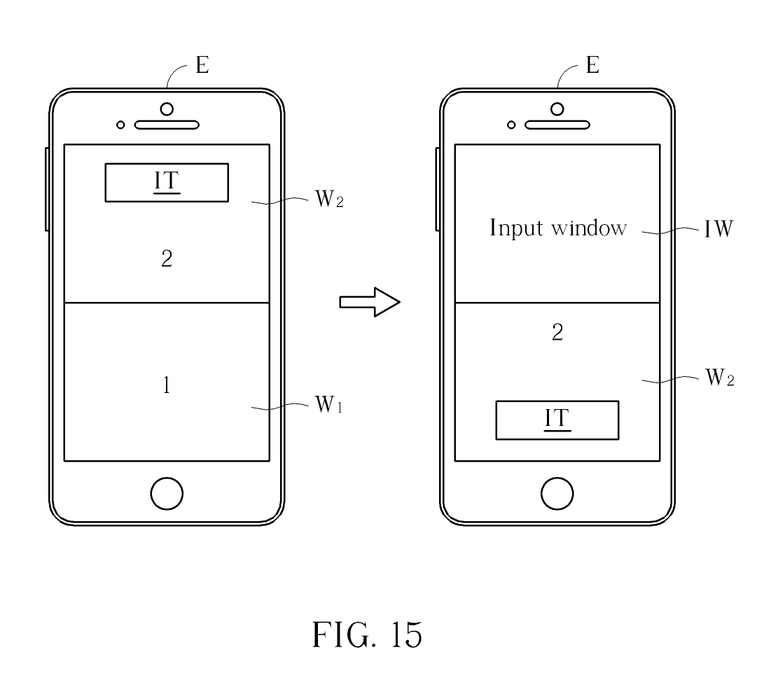

FIG. 14 and FIG. 15 are schematic diagrams illustrating extending embodiments for the embodiments shown in FIG. 12, FIG. 13. The steps in FIG. 14 are similar with the steps in FIG. 12.

The differences between the embodiments of FIG. 12 and FIG. 14 are as follows:

Step 1411 comprises “Determine if the window to be focused is at the top side.” rather than “Determine if the window to be focused is at the bottom side.” in the step 1211. Also, step 1415 comprises “Display the input window at the top side.” rather than “Display the input window at the bottom side.”

Please refer to FIG. 8, in FIG. 8 the input triggering window IT is on a first window W₁ at the bottom side of the electronic apparatus and the window to be focused is the first window W₁ as well. Therefore, the embodiment in FIG. 8 follows the steps 1411, 1415 such that the input window IW is displayed at the top side.

Please refer to FIG. 15, in FIG. 15 the input triggering icon IT is on the second window W₂ and the window to be focused is the second window W₂ as well. Therefore, the embodiment of FIG. 15 follows the steps of 1411, 1413, and 1415, thus the input window IW is displayed at the top side and the first window, the second window are swapped.

The above-mentioned embodiments can be summarized as follows: An electronic apparatus controlling method, applied to an electronic apparatus in a portrait mode, wherein the electronic apparatus displays a first window and second window thereon an displays a input window if receiving an input triggering signal. The electronic apparatus controlling method comprises: (a) before displaying the input window, determining which one of the first window and the second window is the input window displayed in; (b) displaying the input window if the step (a) determines that the input window is displayed on the second window of the electronic apparatus, wherein the input interface displayed via the step (b) does not substantially overlap the first window (such as the embodiments in FIG. 3, FIG. 4, FIG. 8, FIG. 9). (c) swapping the first window and the second window and displaying the input window if the step (a) determines that the input window is displayed on the first window of the electronic apparatus, wherein the input interface displayed via the step (c) does not substantially overlap the second window (such as the embodiments in FIG. 5. FIG. 6, FIG. 10, FIG. 11, FIG. 13, FIG. 15).

If the first window is at the top side and the second window is at the bottom side, the method corresponds to the embodiments in FIG. 3-FIG. 6, and FIG. 13. If the first window is at the bottom side and the second window is at the top side, the method corresponds to the embodiments in FIG. 8-FIG. 11, and FIG. 15.

The electronic apparatus controlling method can further comprise: determining if the input window substantially overlaps the input triggering icon; and moving the first window and the second window thereby the input window does not substantially overlap the input triggering icon (such as the embodiments in FIG. 4. FIG. 6, FIG. 9, FIG. 11).

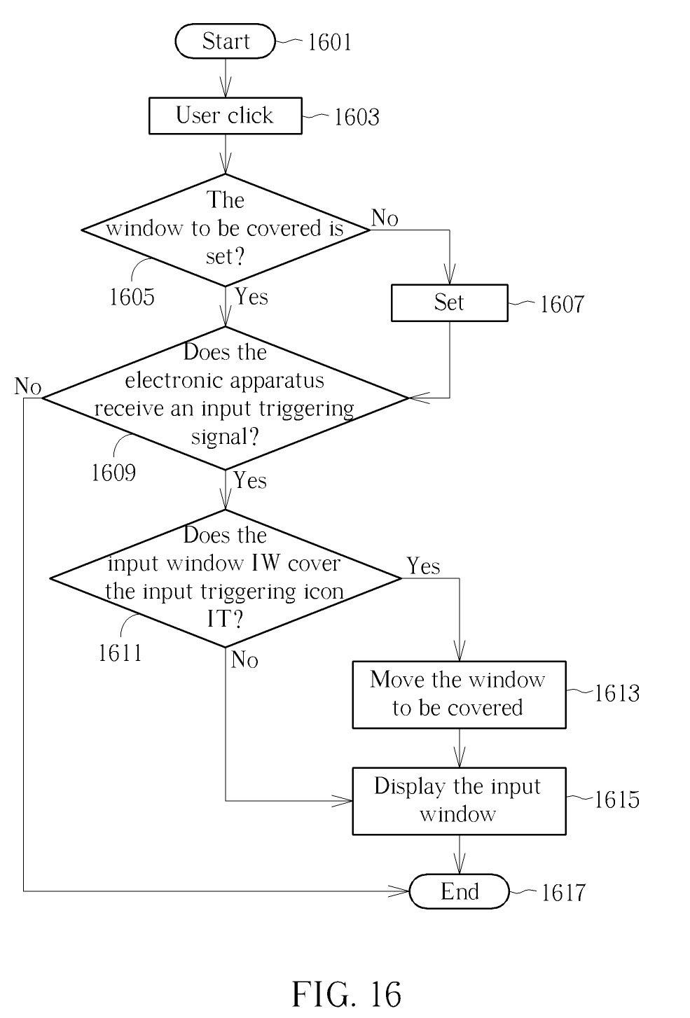

FIG. 16 is a flow chart illustrating the operation for a mobile electronic apparatus in a landscape mode according to one embodiment of the present application. FIG. 16 comprises the steps 1601-1609. The steps 1601 to 1609 are the same as the steps 201 to 209, thus are omitted for brevity here. The contents for the steps 1611-1615 are as follows:

Step 1611

Determine if the input window IW covers the input triggering icon IT? If yes, go to step 1613, if not, go to step 1615.

Step 1613

Move the window to be covered.

Step 1615

Display the input window on the window to be covered.

Step 1617

End.

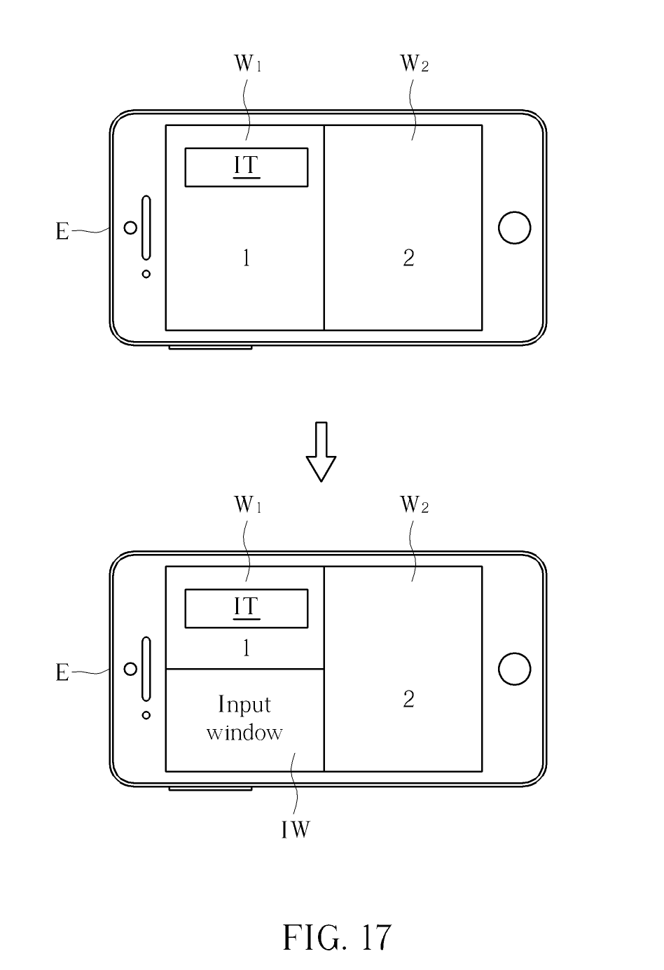

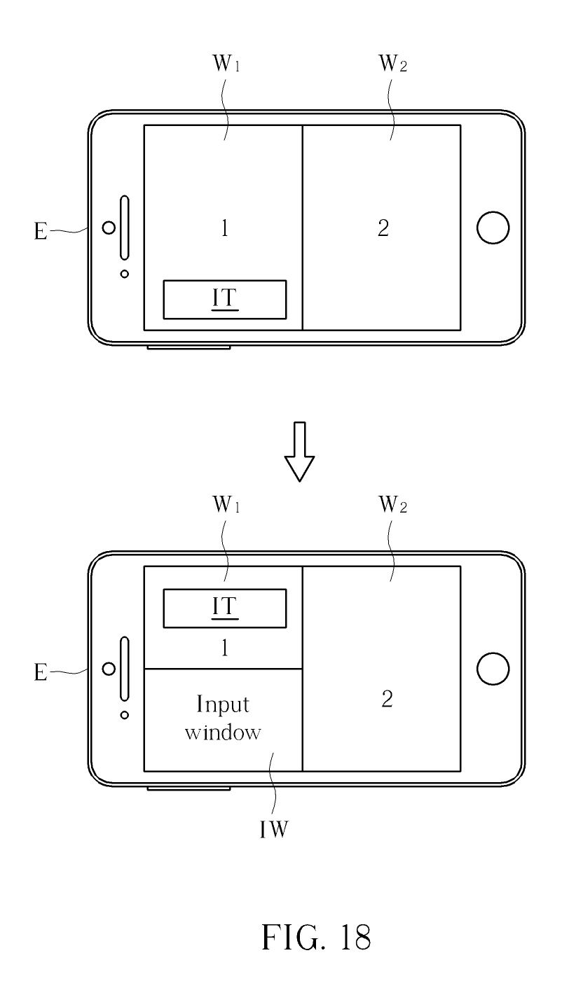

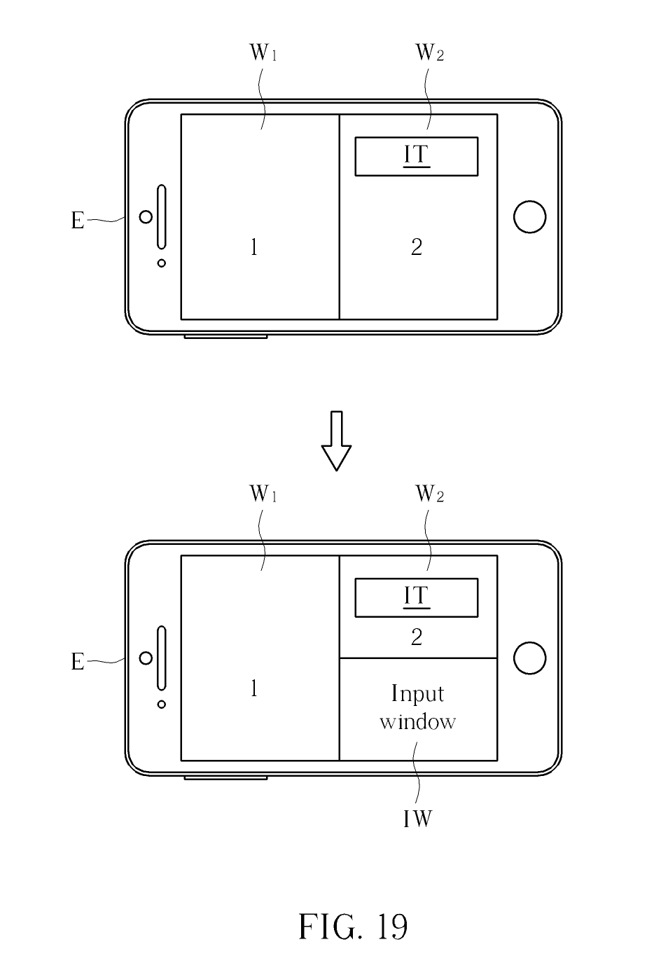

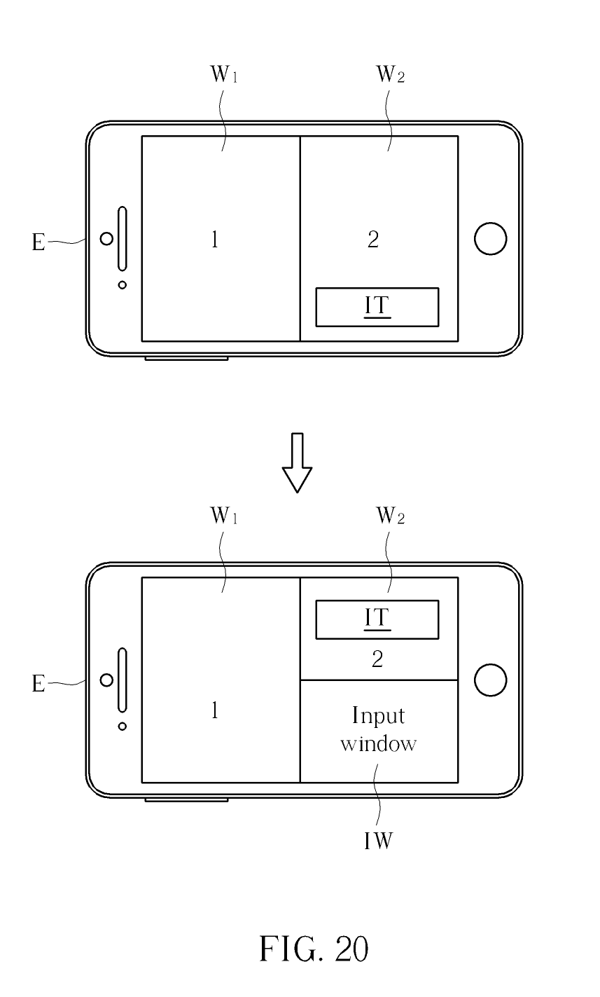

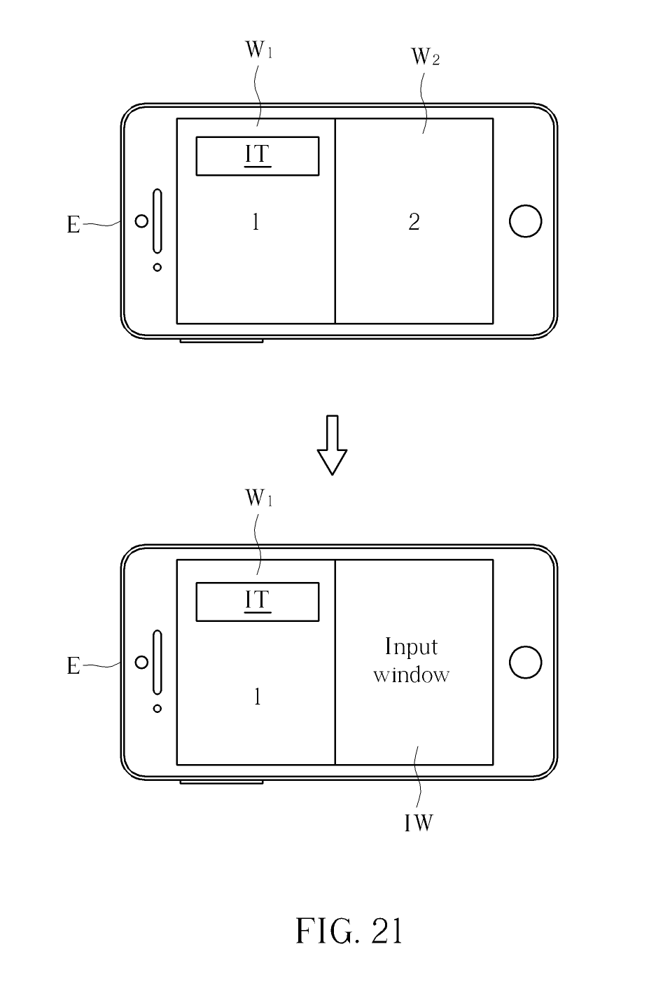

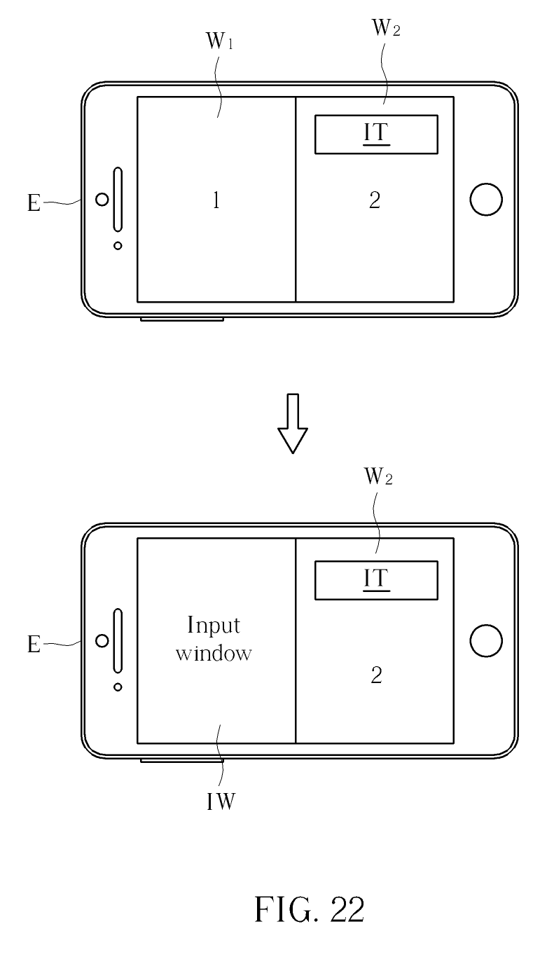

Please note the flow chart in FIG. 16 sets the window to be covered, but can also sets the window to be focused. For the embodiment in FIG. 17, the input window IW does not cover the input triggering icon IT, therefore such embodiment follows the steps 1611 and 1615. For the embodiment in FIG. 18, the input window IW does not cover the input triggering icon IT, therefore such embodiment follows the steps 1611, 1613 and 1615. The embodiments in FIG. 19, FIG. 20 respectively correspond to the embodiments in FIGS. 17 and 18, the only difference between the embodiments in FIGS. 17 and 18 and the embodiments in FIGS. 19 and 20 is that the input triggering icon IT and the input window IW are located on the first window in FIGS. 17 and 18 but are located on the second window in FIGS. 19 and 20. The embodiments in FIG. 21 and FIG. 22, the input window IW and the input triggering icon IT are located in different windows, thus these embodiments both follow the steps 1611, 1615.

Therefore, the embodiments in FIG. 16-FIG. 22 can be summarized as follows:

An electronic apparatus controlling method, applied to an electronic apparatus in a landscape mode. The electronic apparatus displays a first window and second window thereon and displays a input window if receiving an input triggering signal generated via an input triggering icon displayed on the electronic apparatus being activated. The electronic apparatus controlling method comprises: (a) before displaying the input window, determining if the input window substantially overlaps the input triggering icon; (b) displaying the input window if the step (a) determines the input window does not substantially overlap the input triggering icon; and (c) moving the first window or the second window which the input triggering icon is provided in, if the step (a) determines the input window substantially overlaps the input triggering icon, thereby the input window does not substantially overlap the input triggering icon.

The input window and the input triggering icon can be provided at the same side of the electronic apparatus, such as the embodiments in FIGS. 17-20. Also, in another embodiment, the input window and the input triggering icon are provided at different sides of the electronic apparatus, such as the embodiments in FIGS. 21-22. Additionally, the input triggering icon can above the input window, or below the input window.

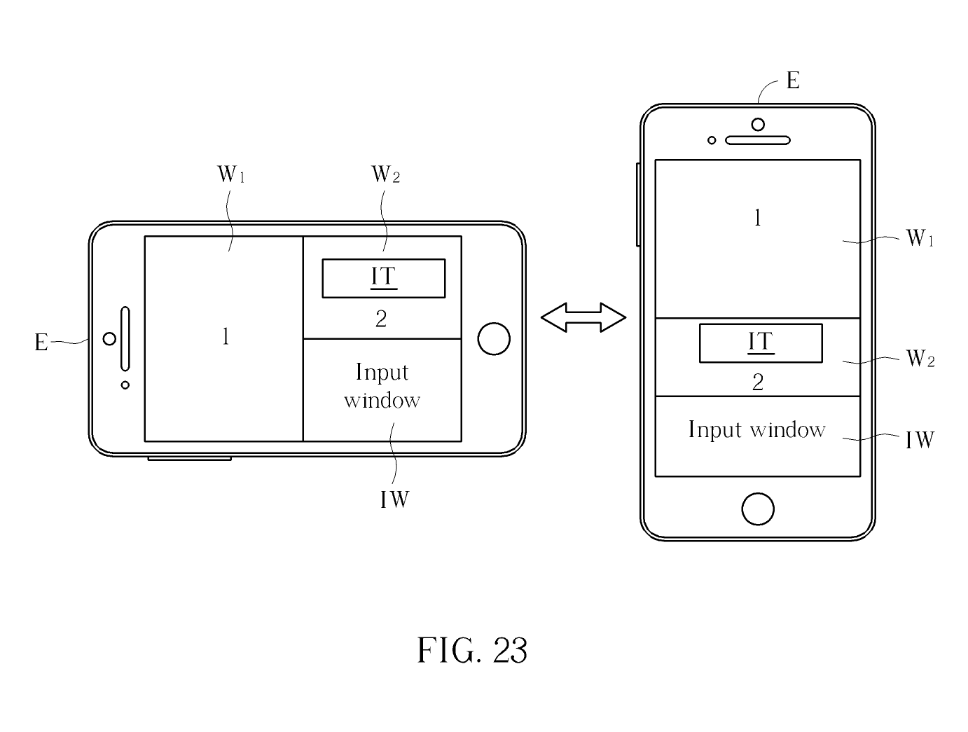

FIG. 23-FIG. 26 are schematic diagrams illustrating the mobile electronic apparatuses in a rotation mode according to the embodiments of the present application. The rotation mode may comprises one of the following operations: rotating from the landscape mode to the portrait mode, and rotating from the portrait mode to the landscape mode.

For the operation of rotating from the landscape mode to the portrait mode, the input window IW can be displayed at a right side if the electronic apparatus E is in the landscape mode and the input window IW can be displayed at a bottom side if the electronic apparatus E is switched from the landscape mode to a portrait mode, as shown in FIG. 23.

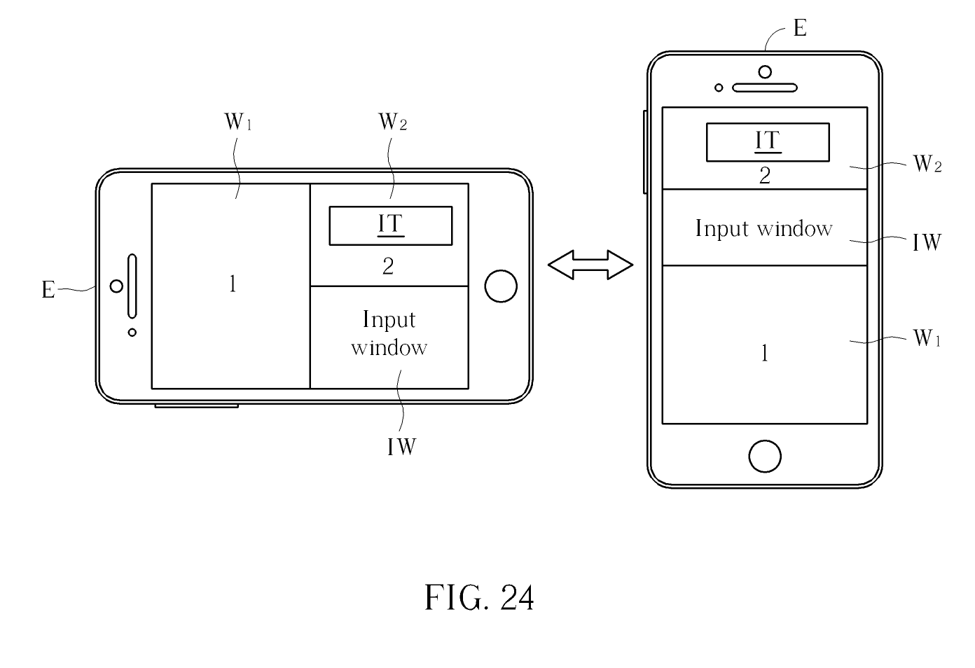

Also, the input window IW can be displayed at a right side if the electronic apparatus E is in the landscape mode and the input window IW can be displayed at a top side if the electronic apparatus E is switched from the landscape mode to a portrait mode, as shown in FIG. 24.

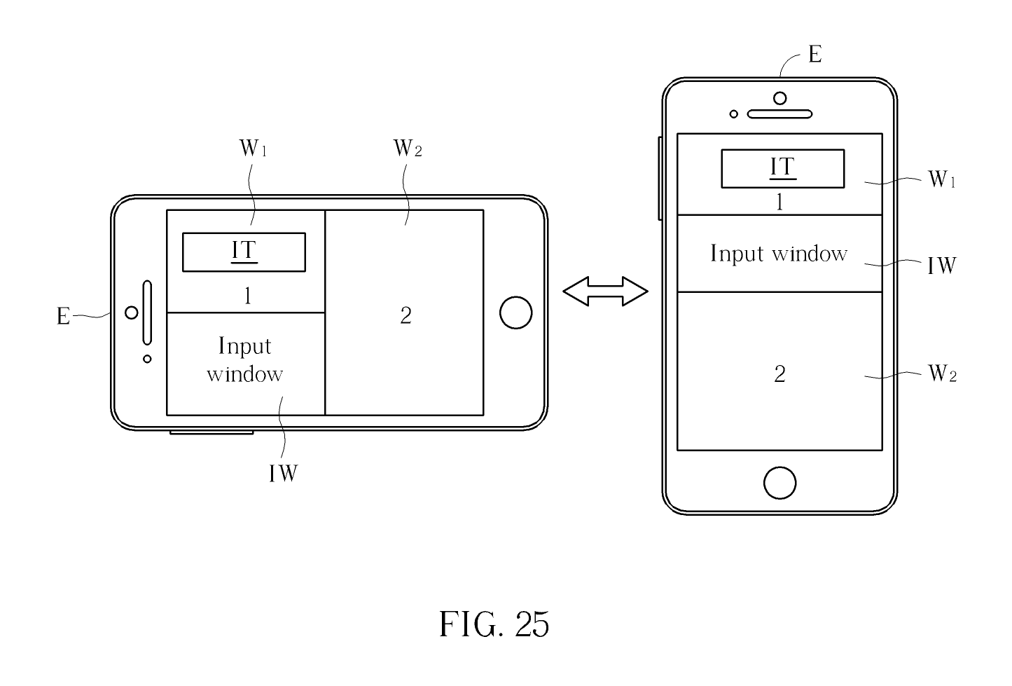

Besides, the input window IW can be displayed at a left side if the electronic apparatus E is in the landscape mode and the input window IW can be displayed at a top side if the electronic apparatus E is switched from the landscape mode to a portrait mode, as shown in FIG. 25.

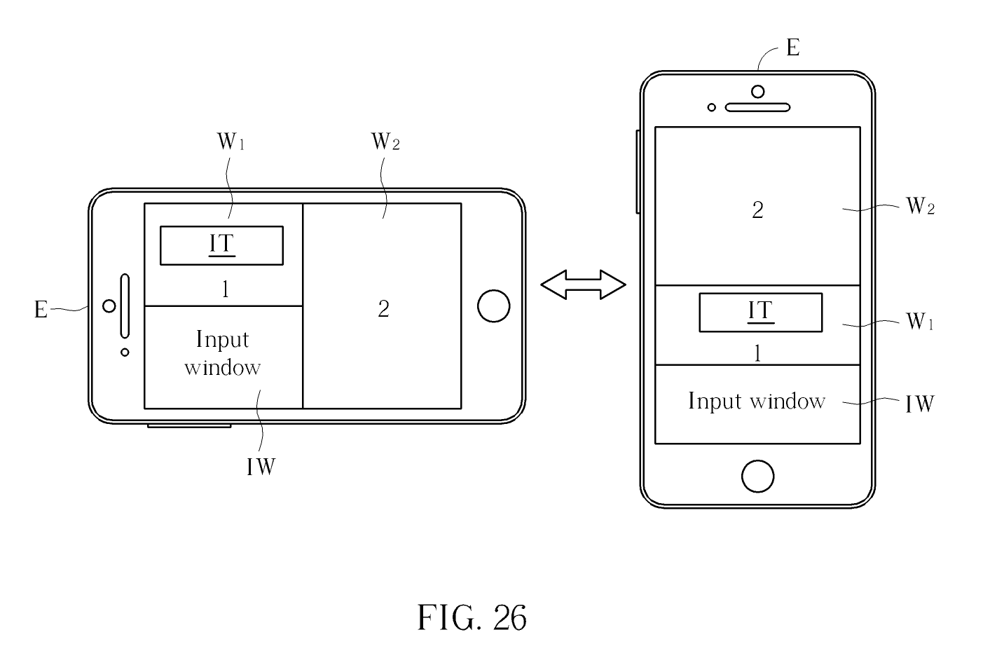

Furthermore, the input window IW can be displayed at a left side if the electronic apparatus E is in the landscape mode and the input window IW can be displayed at a bottom side if the electronic apparatus E is switched from the landscape mode to a portrait mode, as shown in FIG. 26.

For the operation of rotating from the portrait mode to the landscape mode, the input window IW can be displayed at a bottom side if the electronic apparatus E is in the portrait mode and the input window IW can be displayed at a right side if the electronic apparatus E is switched from the portrait mode to the landscape mode, as shown in FIG. 23.

Also, the input window IW can be displayed at an top side if the electronic apparatus E is in the portrait mode and the input window IW can be displayed at a right side if the electronic apparatus E is switched from the portrait mode to a landscape mode, as shown in FIG. 24.

Besides, the input window IW can be displayed at a top side if the electronic apparatus E is in the portrait mode and the input window IW can be displayed at a left side if the electronic apparatus E is switched from the portrait mode to the landscape mode, as shown in FIG. 25.

Furthermore, the input window IW can be displayed at a bottom side if the electronic apparatus E is in the portrait mode and the input window IW can be displayed at a left side if the electronic apparatus E is switched from the portrait mode to the landscape mode, as shown in FIG. 26.

Please note persons skilled in the art can combine any ones of the above-mentioned features, which should also fall in the scope of the present application.

Another aspect of the present application can be show as the following steps. The above-mentioned flow charts in FIG. 2, FIG. 7, FIG. 12, FIG. 14, FIG. 16 can be utilized to reach these steps. In such case, the present application can be summarized as: an electronic apparatus controlling method, applied to an electronic apparatus displaying a first window and second window thereon, comprising: (a) determining one of the first window and the second window as a target window; and (b) displaying an input window on the electronic apparatus if the electronic apparatus receives an input triggering signal. The input window does not substantially overlap any part of the target window.

The step of (a) can be performed via the flow charts in FIG. 2, FIG. 7, FIG. 12, FIG. 14, FIG. 16. Alternatively, the electronic apparatus can receive a target window selecting signal generated by selecting the first window or the second window, to determine the target window. In one example, the target window selecting signal can be generated if the user touches one of the first window and the second window, or generated via another operation such as a gesture, as above-mentioned.

Such aspect can comprise other features. For example, the input window substantially overlaps neither the first window nor the second window, such as the embodiments in FIG. 4, FIG. 6. Also, the above-mentioned step (a) determines the first window or the second window which the input triggering icon is provided in as the target window such as the embodiments in FIG. 3, FIG. 4, FIG. 6, FIG. 8, FIG. 9, FIG. 11, FIG. 13, FIG. 15, FIG. 21, FIG. 22. Also, such aspect can comprise the step of: moving at least one of the first window and the second window, thereby the input window does not substantially overlap the first window and the second window, such as the embodiments in FIG. 4, FIG. 6, FIG. 9, FIG. 11. Additionally, such aspect can comprise the steps of swapping the first window and the second window, such as the embodiments in FIG. 6, FIG. 11, FIG. 13 and FIG. 15.

Besides, the step (a) can determine the first window or the second window which the input triggering icon is not provided in as the target window, such as the embodiments in FIG. 5, FIG. 10, FIG. 17, FIG. 19. In such embodiment, the input window can substantially overlap none of the input triggering icon and swap the first window and the second window, such as the embodiments in FIG. 5, FIG. 10. Furthermore, in theses embodiments, the input triggering icon is above the input window or below the input window.

Please note the above-mentioned embodiments all utilize mobile electronic apparatuses such as a smart phone or a tablet personal computer as examples, but the concept of the present application can be applied to any kind of electronic apparatus.

In view of above-mentioned embodiments, the window that the user desires to see can be avoided to be covered by the input window. Additionally, the present application provides methods to display the input window for different situations, such that the user can select most suitable displaying method corresponding to different requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic apparatus controlling method, applied to an electronic apparatus in a portrait mode, wherein the electronic apparatus displays a first window and second window and displays an input window if the electronic apparatus receives an input triggering signal, wherein the electronic apparatus controlling method comprises:
(a) before displaying the input window, determining which one of the first window and the second window is the input window displayed in;
(b) displaying the input window if the step (a) determines that the input window is displayed on the second window of the electronic apparatus, wherein the input window does not substantially overlap the first window; and
(c) swapping the first window and the second window and displaying the input window if the step (a) determines that the input window is displayed on the first window of the electronic apparatus, wherein the input window does not substantially overlap the second window.

2. The electronic apparatus controlling method of claim 1, further comprising displaying an input triggering icon on one of the first window and the second window, wherein the input triggering signal is generated if the input triggering icon is activated, wherein the step (b) further comprising:
determining if the input window substantially overlaps the input triggering icon; and
moving the first window and the second window thereby the input window does not substantially overlap the input triggering icon.

3. The electronic apparatus controlling method of claim 1, whereon the first window is at a top side of the electronic apparatus, and the second window is at a bottom side of the electronic apparatus.

4. The electronic apparatus controlling method of claim 1, whereon the first window is at a bottom side of the electronic apparatus, and the second window is at atop side of the electronic apparatus.

5. The electronic controlling method of claim 1, wherein the step (b) displays the input window at a top side, where the electronic controlling method further comprises: displaying the input window at a left side if the electronic apparatus is switched from portrait the mode to a landscape mode.

6. The electronic controlling method of claim 1, wherein the step (b) displays the input window at a top side, where the electronic controlling method further comprises: displaying the input window at a right side if the electronic apparatus is switched from portrait the mode to a landscape mode.

7. The electronic controlling method of claim 1, wherein the step (b) displays the input window at a bottom, where the electronic controlling method further comprises: displaying the input window at a left side if the electronic apparatus is switched from portrait the mode to a landscape mode.

8. The electronic controlling method of claim 1, wherein the step (b) displays the input window at a bottom side, where the electronic controlling method further comprises: displaying the input window at a right side if the electronic apparatus is switched from portrait the mode to a landscape mode.

9. The electronic controlling method of claim 1, wherein the step (b) displays the input window in one of the first window and the second window, where the electronic controlling method further comprises: swapping the first window and the second window if the electronic apparatus is switched from the portrait mode to a landscape mode.

10. An electronic apparatus controlling method, applied to an electronic apparatus in a landscape mode, wherein the electronic apparatus displays a first window and second window and displays a input window if receiving an input triggering signal generated if an input triggering icon displayed on the electronic apparatus is activated, wherein the electronic apparatus controlling method comprises:
(a) before displaying the input window, determining if the input window substantially overlaps the input triggering icon;
(b) displaying the input window if the step (a) determines the input window does not substantially overlap the input triggering icon; and
(c) moving the first window or the second window which the input triggering icon is provided in, if the step (a) determines the input window substantially overlaps the input triggering icon, thereby the input window does not substantially overlap the input triggering icon.

11. The electronic apparatus controlling method of claim 10, wherein the input window and the input triggering icon are provided at the same side of the electronic apparatus.

12. The electronic apparatus controlling method of claim 10, wherein the input window and the input triggering icon are provided at different sides of the electronic apparatus.

13. The electronic apparatus controlling method of claim 10, wherein the input triggering icon is above the input window.

14. The electronic apparatus controlling method of claim 10, wherein the input triggering icon is below the input window.

15. The electronic controlling method of claim 10, wherein the step (b) displays the input window at a right side, where the electronic controlling method further comprises: displaying the input window at a bottom side if the electronic apparatus is switched from the landscape mode to a portrait mode.

16. The electronic controlling method of claim 10, wherein the step (b) displays the input window at a right side, where the electronic controlling method further comprises: displaying the input window at a top side if the electronic apparatus is switched from the landscape mode to a portrait mode.

17. The electronic controlling method of claim 10, wherein the step (b) displays the input window at a left side, where the electronic controlling method further comprises: displaying the input window at a bottom side if the electronic apparatus is switched from the landscape mode to a portrait mode.

18. The electronic controlling method of claim 10, wherein the step (b) displays the input window at a left, where the electronic controlling method further comprises: displaying the input window at a top side if the electronic apparatus is switched from the landscape mode to a portrait mode.

19. The electronic controlling method of claim 10, wherein the step (b) displays the input window in one of the first window and the second window, where the electronic controlling method further comprises: swapping the first window and the second window if the electronic apparatus is switched from the landscape mode to a portrait mode.

20. An electronic apparatus controlling method, applied to an electronic apparatus displaying a first window and second window thereon, comprising:
(a) determining one of the first window and the second window as a target window; and
(b) displaying an input window on the electronic apparatus if the electronic apparatus receives an input triggering signal;
wherein the input window does not substantially overlap any part of the target window.

21. The electronic controlling method of claim 20, wherein the step (a) receiving a target window selecting signal generated by selecting the first window or the second window, to determine the target window.

22. The electronic controlling method of claim 20, wherein the input window substantially overlaps neither the first window nor the second window.

23. The electronic controlling method of claim 20, further comprising displaying an input triggering icon in one of the first window and the second window, wherein the input triggering signal is generated if the input triggering icon is activated, wherein the step (a) determines the first window or the second window which the input triggering icon is provided in as the target window.

24. The electronic controlling method of claim 23, further comprising:
moving at least one of the first window and the second window, thereby the input window do not substantially overlap neither the first window nor the second window.

25. The electronic controlling method of claim 24, further comprising:
swapping the first window and the second window.

26. The electronic controlling method of claim 23, further comprising:
swapping the first window and the second window.

27. The electronic controlling method of claim 20, further comprising displaying a input triggering icon in one of the first window and the second window, wherein the input triggering signal is generated if the input triggering icon is activated, wherein the step (a) determines the first window or the second window which the input triggering icon is not provided in as the target window.

28. The electronic controlling method of claim 27, wherein the input window does not substantially overlap the input triggering icon.

29. The electronic controlling method of claim 28, further comprising: swapping the first window and the second window.

30. The electronic controlling method of claim 27, wherein the input triggering icon is above the input window.

31. The electronic controlling method of claim 27, wherein the input triggering icon is below the input window.

32. The electronic controlling method of claim 20, wherein the step (b) displays the input window at a right side if the electronic apparatus is in a landscape mode, where the electronic controlling method further comprises: displaying the input window at a bottom side if the electronic apparatus is switched from the landscape mode to a portrait mode.

33. The electronic controlling method of claim 20, wherein the step (b) displays the input window at a right side if the electronic apparatus is in a landscape mode, where the electronic controlling method further comprises: displaying the input window at a top side if the electronic apparatus is switched from the landscape mode to a portrait mode.

34. The electronic controlling method of claim 20, wherein the step (b) displays the input window at a left side if the electronic apparatus is in a landscape mode, where the electronic controlling method further comprises: displaying the input window at a bottom side if the electronic apparatus is switched from the landscape mode to a portrait mode.

35. The electronic controlling method of claim 20, wherein the step (b) displays the input window at a left side if the electronic apparatus is in a landscape mode, where the electronic controlling method further comprises: displaying the input window at a top side if the electronic apparatus is switched from the landscape mode to a portrait mode.

36. The electronic controlling method of claim 20, wherein the step (b) displays the input window in one of the first window and the second window if the electronic apparatus is in a landscape mode, where the electronic controlling method further comprises: swapping the first window and the second window is switched from the landscape mode to a portrait mode.
